(19) United States
(12) Patent Application Publication
(10) Pub. No.: US 2006/0256968 A1
(43) Pub. Date: Nov. 16, 2006

(54) Telephone communication system

(75) Inventor: Eric Lemasson, Pitres (FR)

Correspondence Address: LOWE HAUPTMAN BERNER, LLP, 1700 DIAGONAL ROAD, SUITE 300, ALEXANDRIA, VA, 22314, US

(73) Assignee: Sagem Communication, Paris Cedex 12 (FR)

(21) Appl. No.: 10/550,508

(22) PCT Filed: Mar. 19, 2004
(86) PCT No.: PCT/FR04/00672

§ 371 Date: May 23, 2006

(30) Foreign Application Priority Data
Mar. 24, 2003 (FR) 03/03803

(51) Int. Cl. H04K 1/00

(52) U.S. Cl. 380/270

(57) ABSTRACT

A telephone communication system comprising a radiocommunication module (10) and a data encryption/decryption module (28), characterized in that the radiocommunication module (10) comprises a modem interface module (20) which is connected to the radiocommunication module (10) and controls an external modem (33). The encryption/decryption module (28) comprises a microcircuit support reader, an encryption/decryption circuit (29) and a vocoder circuit (30) receiving voice data to be encrypted or decrypted from the communication module (10). The encryption/decryption (29) of data is carried out directly in the encryption/decryption circuit (29) of the encryption/decryption module.

### FIELD OF THE INVENTION

This present invention concerns a telephone communication system that provides its user with the ability to choose several methods of communication with his or her correspondent. What is referred to here is communication, either in plain language or encoded, of speech or data.

This present invention aims in particular to allow such communication in all geographical zones, whether covered or not by a cellular radio network.

### BACKGROUND OF THE INVENTION

One is familiar with previous designs of fixed or mobile telephones that use encrypted communications in order to protect conversations from end to end of the network. These telephones require an appliance or an extension, which enables this encryption to be effected. It is necessary that both participants in an encrypted conversation should be in possession of a tool for encryption and decryption of the data.

More particularly, mobile telephones need a technology that is discreet and easy to use. One is familiar, through patent EP 0 818 937 A1, with a radiotelephone communication device which is used to encrypt a conversation and which employs the data transmission channel. This equipment includes a mobile telephone of the GSM type, with a microphone and a receiver. This telephone is connected, by a wire connection, to an extension unit, which effects the encryption of the conversation. The extension unit has an outward appearance resembling that of a radio communication terminal and has at least a vocoder and an encryption module. In a secured communication mode, the vocoder forms, from the signal output by the microphone, a binary stream which the encryption module processes to produce data that is sent via a data interface to the terminal, for transmission on a data channel. On receipt, the data presented to the data interface after receipt on a data channel are decrypted by the encryption module to produce a binary stream that the vocoder decodes to drive the receiver. This patent thus makes use of the presence of data channels on certain radiotelephone networks.

One is familiar, through patent FR 2 809 920, with a mobile telephone with a radiotelephone communication terminal in which the dust cover has been modified. This cover includes a reader for microcircuit media allowing the insertion of a smartcard that can be used for the encryption of the data. In the event that the data has to be made secure, an encryption program is provided in a program memory of the smartcard or in the program memory of the main unit.

The encrypted conversations or communications from or to a mobile telephone are transmitted by means of the mobile radiotelephone network.

Another use of the mobile telephone of the GSM type is the transmission of data by connection of the modem of a laptop computer to a mobile telephone. Thus the computer controls the mobile telephone through its modem and is able to send to the outside or receive data from the computer via the radio communication network. Such a device is known from patent application GB230343.

However, when the user of a mobile telephone travels in a country or a region with no cellular radiotelephone network, he cannot use his mobile telephone either as a modem or as means of communication, even if a switched telephone system exists or other communication resources are available. Up to the present, it has not been possible to send encrypted data via the SM radiotelephone network.

### GENERAL DESCRIPTION OF THE INVENTION

The purpose of this present invention is therefore to overcome the drawbacks of previous designs by proposing a mobile telephone driving an external modem to transmit an encrypted conversation over the STN network (switched telephone network) or via an Immarsat type terminal which redirects the data to a satellite. This is the Modem mode. This present invention also allows the transmission of encrypted data when the mobile telephone is configured as a modem sender.

This aim is accomplished by a telephone communication system that includes a radiocommunication module and a data encryption/decryption module, characterised in that:
the radiocommunication module includes a modem interface module linked to the radiocommunication module and controlling an external modem;
the encryption/decryption module includes a reader for microcircuit media, an encryption/decryption circuit, and a vocoder circuit receiving the speech data from the radiocommunication module to be encrypted or to be decrypted, where the encryption/decryption of the data is effected directly in the encryption/decryption circuit of the encryption/decryption module.

According to another particular feature, the radiocommunication module includes a first routing of the encrypted speech data to the modem interface or to a modulation/demodulation circuit, composed of a software-controlled switching resource.

According to another particular feature, the radiocommunication module includes a second routing of the data from the modem to the encryption/decryption module or to a modulation/demodulation circuit, composed of a software-controlled switching resource.

According to another particular feature, the radiocommunication module includes at least one control for the menu displayed on a display device of the terminal, allowing one to choose conversation and transmission mode.

According to another particular feature, the encryption/decryption module is housed in a cover unit that is linked to the terminal module by a contactor.

According to another particular feature, the encryption/decryption module includes a data media reader for the exchange only of the user's encryption session keys.

According to another particular feature, the radiocommunication module includes a serial connection to an external modem.

According to another particular feature, the telephone communication system is characterised in that the serial connection is of the RS232 wire type.

According to another particular feature, the serial connection is not of the wire type.

According to another particular feature, the serial connection, not of the wire type, is infrared.

According to another particular feature, the serial connection, not of the wire type, is 802.11 radio (Wifi).

According to another particular feature, the serial connection, not of the wire type, is bluetooth.

According to another particular feature, the conversation mode selected by the menu is a telephone call in plain language through the cellular radiotelephone network, directly connecting a DSP on send or receive with a radio modulation-demodulation circuit of the radiocommunication module.

According to another particular feature, the conversation mode selected by the menu is an encrypted telephone call through the cellular radiotelephone network, where this mode inserts the encryption/decryption module between a DSP and a radio modulation/demodulation circuit of the radiocommunication module, by switching the first routing.

According to another particular feature, the conversation mode selected by the menu is an encrypted telephone call through the switched telephone network or a satellite, via an external modem driven by the radiocommunication module, where this mode inserts, between the DSP and the encryption/decryption module by switching the first routing, a vocoder circuit that adapts the digital signals of the DSP to the transmission speed of a modem before sending them to the encryption/decryption circuit and diverting the signals coming from the external modem and exiting from the encryption/decryption circuit to a loudspeaker, and those coming from a microphone and exiting from the encryption/decryption circuit to the external modem.

According to another particular feature, the mode of transmission of the data selected by the menu is a plain-language telephone transmission through the cellular radiotelephone network connecting the modem interface module with a radio demodulation-demodulation circuit, by switching the second routing.

According to another particular feature, the mode of transmission of the data selected by the menu is an encrypted telephone transmission over the cellular radiotelephone network inserting, the encryption/decryption module between the modem interface module and radio modulation-demodulation circuit, by switching the second routing.

### BRIEF DESCRIPTION OF THE FIGURES

Other particular features and advantages of this present invention will appear more clearly on reading the following description, provided with reference to the appended figures, in which:

FIG. 1 shows a communication arrangement according to the invention;

FIG. 2 is a block diagram of principal communication unit and an encryption module according to the invention;

FIG. 3A is a block diagram of the speech path during a plain-language call;

FIG. 3B is a block diagram of the data path during a plain-language call;

FIG. 4A is a block diagram of the speech send and receive path during an encrypted call operating on all the GSM networks;

FIG. 4B is a block diagram of the data transfer during an encrypted call operating on all the GSM networks;

FIGS. 5A and 5B respectively show a block diagram of the routing of the speech send and receive path during an encrypted call on all the line and/or satellite networks (Modem mode);

FIG. 6 is a block diagram of a SIM card.

### DESCRIPTION OF PREFERRED EMBODIMENTS OF THE INVENTION

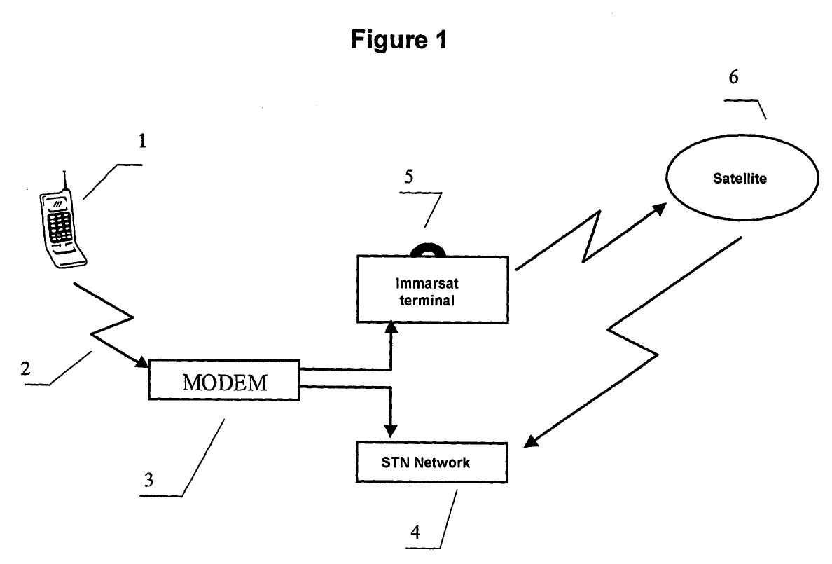

FIG. 1 represents a mobile telephone (1) linked to an external modem (3) via a serial connection (2) for example, of the wire type or not, and in particular of the 802.11 radio or bluetooth or infrared type. The modem (3) is linked to the switched telephone network (STN) (4) or to an Immarsat terminal type (5) which communicates by radio with a satellite (6), with the latter retransmitting the information to the STN network (4). With the telephone (1) according to the invention, if the user is in a zone not covered by the cellular radiotelephone network, he can use the invention to communicate via the modem interface of the telephone, in an encrypted fashion or not, with a third person, via the switched telephone network for example.

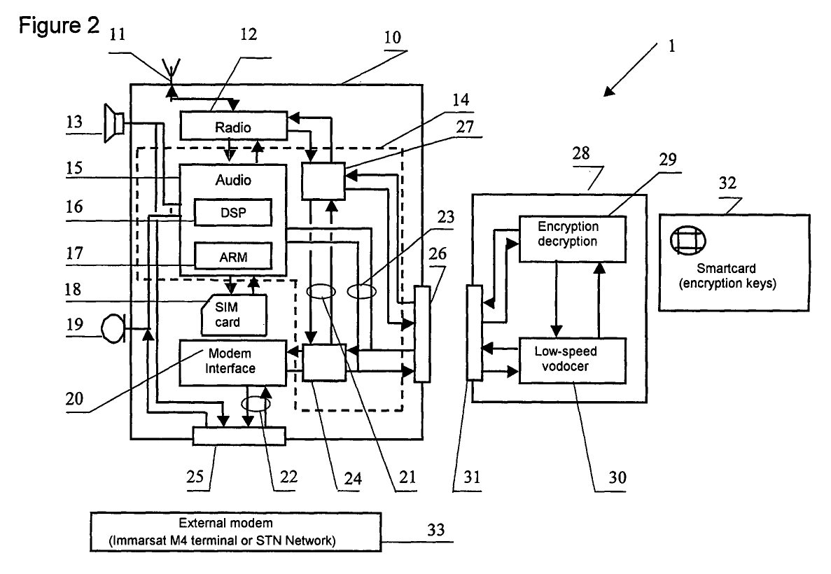

FIG. 2 shows a mobile telephone (1) that includes a main radio unit (10) and an encryption module (28).

The mobile telephone includes a baseband circuit (14) which includes:
an audio module (15) with two microprocessors, one a microprocessor for the processing of digital signals of the DSP type (16), which performs the vocoder function and adapts the data speed to the GSM network (13,000 bauds). This DSP microprocessor (16) processes the data and is used to make up TDMA frames (time division multiple access). The audio module includes a microprocessor of the ARM type (17) which is equivalent to a RISC processor (Reduced Instruction Set Computer) which is used to improve the performance of the system by using a reduced instruction set. This microprocessor manages all of the telephone, including the screen display, handling of the numerical keypad, the various programming menus, and the software connection of the GSM baseband circuits (14);
a modem interface module (20), which is linked to the radio module (12) by a data bus (21), to supply it with the data to be transmitted on a given channel of the network radio, and to transmit demodulated data to a data input/output unit (modem and/or micro-computer), after receipt on a data channel of the network radio. This modem interface module (20) redirects the data via a serial connector (25) of the RS232 type for example, to an external accessory such as an external modem (33) or a laptop computer;
a software switching resource (27) used to route encrypted speech data, either to the radio module to effect a transfer to the cellular network, or to the modem interface module to effect a transfer to the STN network for example;
a software switching resource (24) used to route data coming from a laptop computer via a external modem for example, either to the radio module to the data in plain language to the GSM network, or to the encryption/decryption module (28) which will encrypt the data before sending them on to the radio module (12).

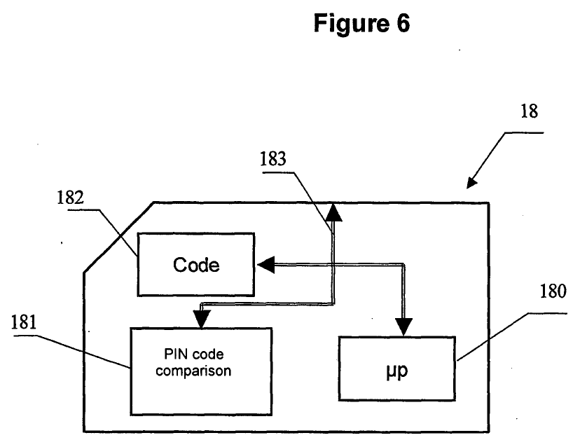

The mobile telephone also includes:
a radio module (12) modulating and demodulating the information signals to and from an antenna (11), which sends or receives data from or to the outside. (The radio module (12) is outside the baseband circuit (14)—see FIG. 2)
a microphone (19) which is used to retransmit the speech in an analogue manner;
a receiver (13) which converts an analogue signal into sound;
a SIM card connector (not shown) connected to a SIM card (18);
a SIM card (18) which includes elements characterising the relationship that exists between a mobile telephone operator and a user of the mobile telephone. FIG. 6 is a block diagram of the SIM card, which includes a microprocessor (180), a program memory (181), and a data memory (182), connected together by means of a bus (183);
a rechargeable battery (not shown) which powers the telephone (10) and the encryption module (28);
a encryption module connector (26) which is used to transmit the data, in plain language or encrypted form, from or to the encryption unit (28) via a DAI link (Digital Audio Interface) (23);
a serial connector (25), of the wire type or not, which is used for example to recharge the battery or to transfer the information between the telephone (10) and an external modem (33). This connector includes several inputs-outputs, two of which (22) are dedicated to transmission of the data between an external modem and the modem interface, others being connected to the receiver, the microphone, and a final one to the audio module.

The encryption module (28) includes:
un encryption module connector (31) which is used to connect the encryption/decryption module to the terminal unit (10) via a DAI link (Digital Audio Interface) (23). The latter includes 4 wires for communication between the two units on both send and receive to and from the vocoder (30) or the encryption/decryption circuit (29). This connector (31) is in contact with a identical connector (26) on the terminal unit (10)
a smartcard reader connector (not shown) which includes feelers that are intended to make contact with metalled areas on the chip of a smartcard (32);
a data encryption/decryption circuit (29) linked to the aforementioned connector;
a low-speed vocoder (30) which effects a digitisation and undigitisation of the data, in order to adapt them to the data speed (9600 bauds) when the data have to travel over the STN network, for example.

A smartcard (32) that can be inserted into smartcard reader slot of the encryption module can be a charging card or one to save encryption keys in secret key encryption. In the case of public key encryption, the smartcard is a secure repository for the creation of a session key supplied to the encryption module at each communication. This card (32) avoids downloading the secret elements of a user into the mobile telephone (10), an act which would render it vulnerable. In fact, when the keys are loaded, they remain so.

To bring the mobile telephone into use, the user keys in a number, called the PIN code, via the keypad of the telephone. This code is transmitted to the SIM card (18) by means of a program for switching on the audio module. Once the PIN code has been sent to the SIM card, a program is executed under the command of the microprocessor (180) of the SIM card (18). In the program memory (181), the PIN code is compared to a code stored in a memory (182) of the SIM card (18). If the comparison is positive, the start-up of the telephone is enabled and the user can select the operating mode for the call.

If we refer to the previous techniques, two types of communication data are possible, namely speech data processed by the audio module and data coming from an external accessory, such as from a laptop computer using the telephone as a sender modem.

There are three ways to transfer the speech data using the invention, namely a standard conversation in plain language by means of the mobile radiotelephone network, an encrypted conversation by means of the mobile radiotelephone network, and an encrypted conversation (Modem mode) by means of a modem interface (20) controlled by the mobile telephone (1) to a line and/or satellite communication network. The first two conversation methods are already known. The third conversation mode concerns the invention.

The transfer of the data, from a laptop computer for example, can be done in two ways, namely transfer of the data in plain language via the GSM network, and transfer of the data in encrypted form via the GSM network. The first transfer method is already known, and the second concerns a particular feature of the invention.

Using the interactive aspects of his GSM telephone, the user will first have selected the operating mode for the five possible correspondences to the following explanations. For example, these interactive aspects are an up-down button which, when operated by the user, brings up the following choices in the desired section of the menu for use of the telephone—a GSM speech call in plain language, a GSM speech call in encrypted form, a Modem speech call in encrypted form, a GSM data call in plain language, or a GSM data call in encrypted form. The user selects the operating mode of his choice by pressing the up-down button to bring a marker level with or coinciding with the choice concerned, and then validates his choice with a validation button.

When a user wished to make a call, he can choose one of the three communication modes using the menu offered on his telephone. This menu is managed by the ARM type microprocessor (17) in the baseband module (14) for example. When a user answers a call, the conversation mode is not programmed via the menu, but is switched in automatically. The mobile telephone polls the data transmission coming either from the cellular radiotelephone network or from an accessory such as the external modem.

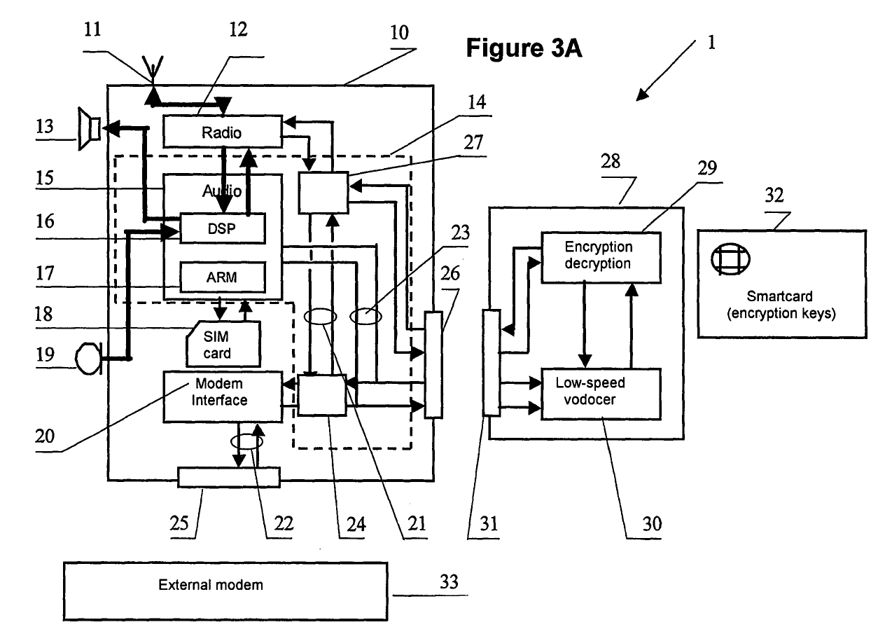

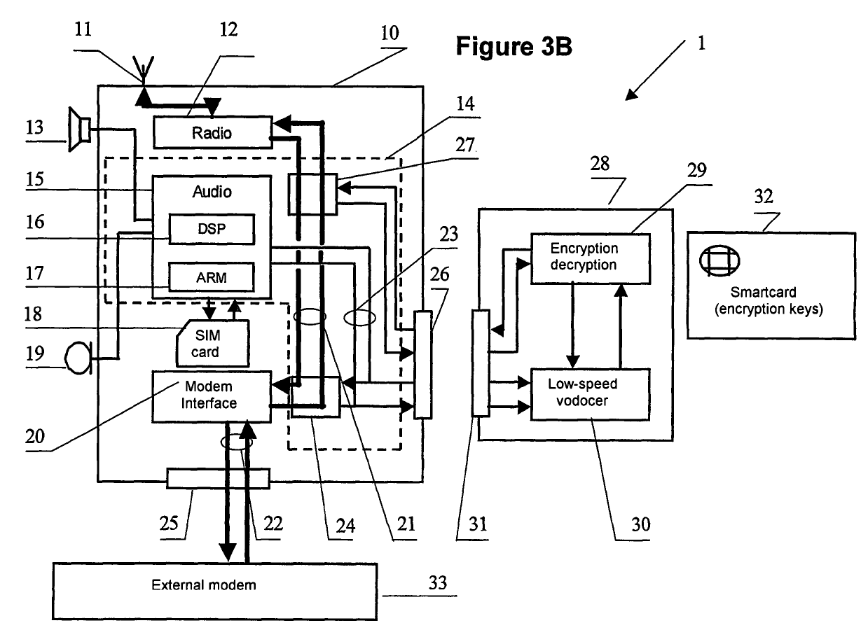

FIG. 3A represents the speech path during a plain-language call through the GSM network. During a standard communication in plain language, speech coming from the microphone (19) is digitised on transmit by the DSP microprocessor (16) of the audio module (15) at the usual speed of the GSM network (13,000 bauds). The radio module (12) will then modulate this signal so as to send it to the outside by means of the antenna (11).

On receipt, the speech data from the outside arriving at the antenna (11) are demodulated by the radio module (12), undigitised by the audio module (15), and sent to the receiver (13).

FIG. 3B represents the data path on standard transmit and receive for a plain-language call. On transmit, the data are transferred from the modem (33) to the serial connector (25), which redirects them to the modem interface (20). The latter sends the data to the radio module (12) via the data bus (21). The switching unit (24) switches in so that the data are redirected to the radio module (12). The latter will then modulate this signal so as to send it to the outside via the antenna (11). On receipt, the radio module (12) receives data via the antenna (11). It demodulated them and sends them to the modem interface via the switching unit (24). The modem interface (20) redirects the data to the external modem (33) and to a laptop computer via the serial connector.

In this communication mode; it is the modem that controls the mobile telephone, to transmit data to the GSM network. During the transfer of the data from the modem (33) to the modem interface (20), the modem (33) sends AT commands in the Hayes protocol together with the data.

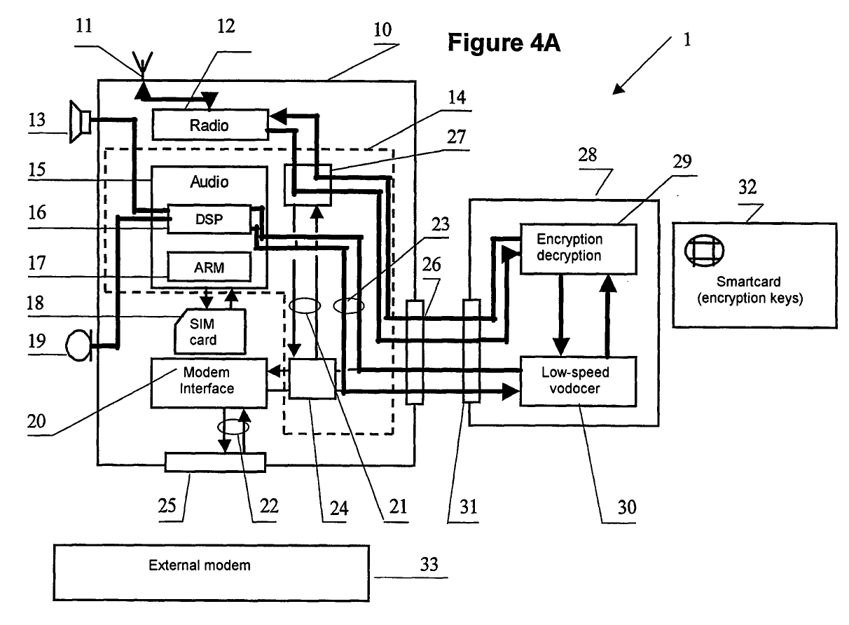

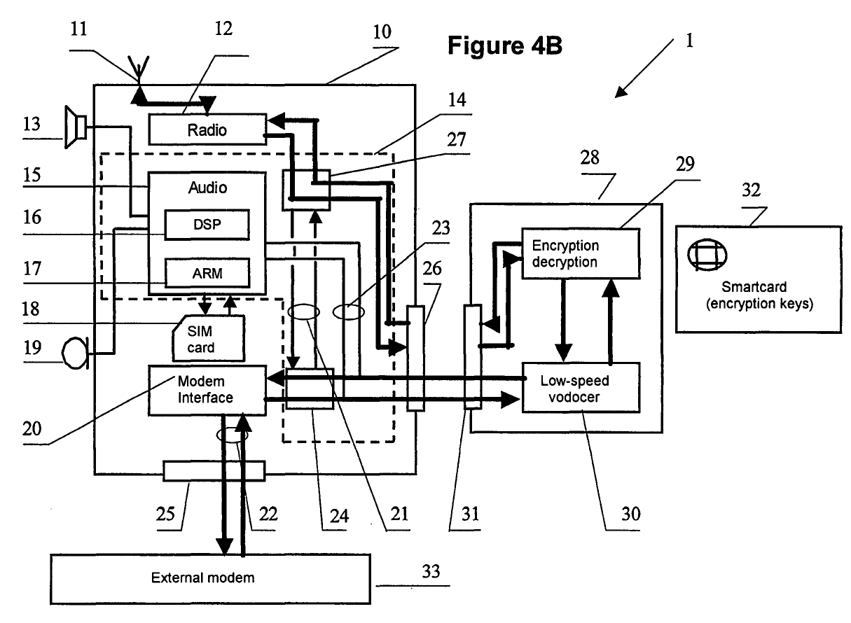

FIG. 4A represents the speech path during an encrypted call over the GSM network. During a conversation that has been encrypted by the GSM network, speech undergoes a first digitisation, to suit the normal GSM speed, by the DSP microprocessor (16) of the audio module (15). The digitised speech data are sent to the vocoder (30) of the encryption/decryption module (28) via a DAI bus (Digital Audio Interface) (23). In this case, the vocoder (30) effects a second processing of the speech data in order to adapt it to the Data mode speed of 9600 bauds, and sends the data to the encryption/decryption circuit (29) which encodes it. The encrypted speech data at the GSM speed are then sent to the radio module (12) via the data bus (21), which transmits them to the outside via the antenna (11).

On receipt, the encrypted speech data arrive at the antenna (11). The radio module (12) transmits them to the encryption module (29), which decrypts them. The speech data are transmitted by the vocoder (30) to the audio module (15) which undigitised them and sends an analogue signal to the receiver (13).

FIG. 4B represents the path of the encrypted data through the mobile telephone network on transmit and receive. On transmit, the data are transferred from the modem (33) to the serial connector (25), which redirects them to the modem interface (20). The latter sends the data to the encryption/decryption module (28) via the switching unit (24). The data are then sent to the vocoder (30) of the encryption/decryption module (28). The vocoder (30) in this case does not perform digitisation of the data suitable for the Data mode speed of 9600 bauds, but simply sends the data to the encryption/decryption circuit (29) which encodes them. The encrypted data are then sent to the radio module (12) via the data bus (21) and the switching unit (27), which transmits them to the outside via the antenna (11).

On receipt, the radio module receives the data via the antenna (11). It demodulates them and sends them to the encryption module via the switching unit (27) and the data bus (21). The encryption/decryption circuit (29) decrypts the encrypted data and transmits them to the vocoder (30). This redirects the data to the modem interface (20) via the connector (31) and the switching unit (24). The modem interface (20) redirects the data to the external modem (33) and the laptop computer via the serial connector (25).

In this communication mode, it is the modem that controls the mobile telephone, to transmit data to the GSM network. During the transfer of the data from the modem (33) to the modem interface (20), the modem (33) sends AT commands in the Hayes protocol together with the data.

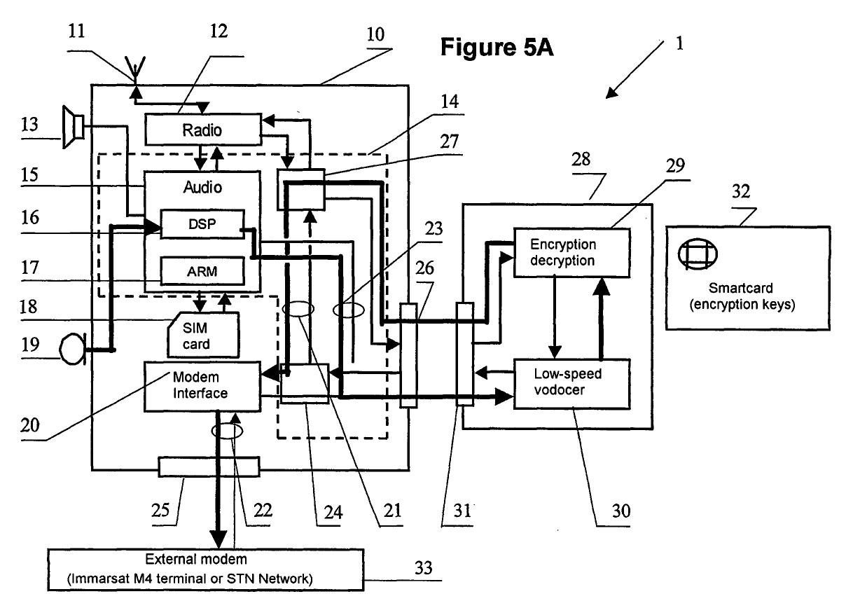

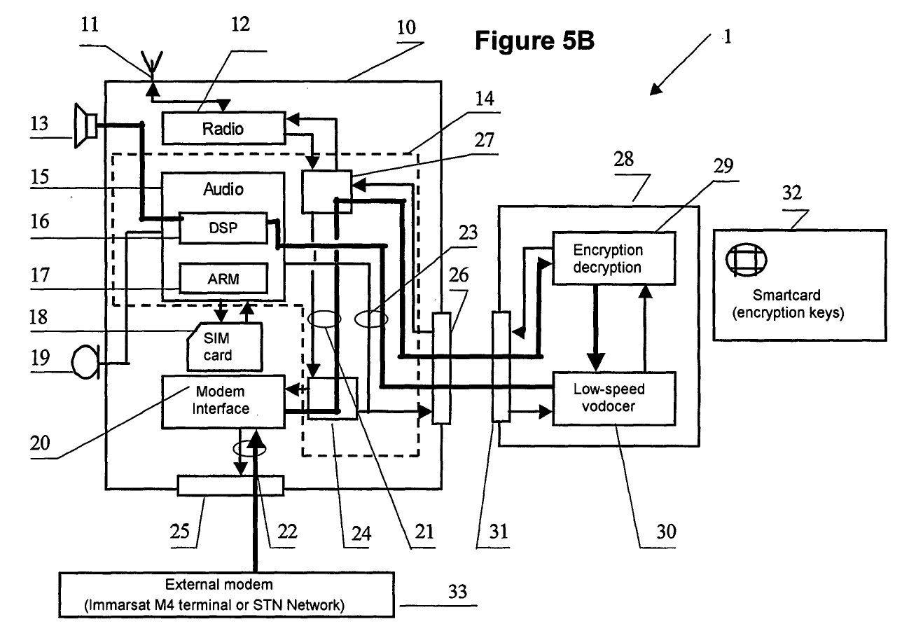

FIG. 5A represents the speech path on transmit during an encrypted call over a line or satellite network (in Modem mode). During an encrypted conversation in Modem mode, speech undergoes a first digitisation matched to the GSM speed type of 13,000 bauds by the DSP digital signal processor (16) of the audio module (15). The digitised speech data are sent via a DAI bus (23) to the vocoder (30) of the encryption/decryption module (28), contained, for example, in a cover unit. The vocoder (30) effects a second digitisation of the speech data, adapting their speed to the Data mode speed, of 9600 bauds for example, of a modem interface and sends these data to the encryption/decryption circuit (29) which encrypts them. The encrypted voice data are then redirected to the modem interface module (20) via the data bus (21). The switching unit (27) of the speech data on the data bus to the modem interface module (20) or to the radio module (12) is managed by ARM type microprocessor (17). The modem interface module (20) is used to send AT commands in the Hayes protocol and the data to the external modem (33) via a serial connector (25) of the RS232 type for example.

FIG. 5B shows encrypted speech data being received from the STN network for example, which are sent from the external modem (33) to the modem interface module (20) via the serial connector (25). This module (20) redirects them to the encryption/decryption circuit (29), which decrypts them. The data are transmitted to the vocoder (30) for a first undigitisation, and are sent to the audio module (15) which effects a second undigitisation before sending them to the loudspeaker (13).

It should be obvious to those skilled in the art that this present invention allows for embodiments in many other specific forms without going beyond of the scope of the invention as claimed. As a consequence, the present methods of implementation should be considered as illustrations only, but can be modified within the range defined by the scope of the attached claims, and the invention should not be limited to the details given above.

1-17. (canceled)

18. A telephone communication system that includes a radiotelephone terminal of the type that includes a radiocommunication module equipped with a radio modulation/demodulation circuit and a data encryption/decryption module, where the radiocommunication module includes a modem interface module connected to the radiocommunication module to control a modem, an encryption/decryption module that includes an encryption/decryption circuit, and a vocoder circuit receiving speech data to be encrypted or decrypted from the radiocommunication module, where the encryption/decryption of the data is effected directly in the encryption/decryption circuit of the encryption/decryption module, characterised in that the radiocommunication module includes at least one control of the menu displayed on a display device of the terminal, allowing one to choose the conversation and transmission mode, and where the system includes:
a reader included in the said encryption/decryption module to receive a microcircuit media of the removable smartcard type,
an external modem separate from the radiotelephone terminal,
data communication resources connected to the radiocommunication module to exchange data between the terminal and the external modem, and
a first software switching resource connected to the radio modulation/demodulation circuit to route the data received by the terminal by means of the radio modulation/demodulation circuit to the modem interface module in order to effect a data transfer intended for the external modem, and conversely, to effect a transmission of data from the radio modulation/demodulation circuit by routing the data received by the terminal by means of the mode interface module interface, where a second software switching resource is provided between the modem interface module and the first software switching resource.

19. A telephone communication system according to claim 18, characterised in that the said first software switching resource includes a switching of the encrypted speech data to the modem interface or to a modulation/demodulation circuit.

20. A telephone communication system according to claim 18, characterised in that the radiocommunication module includes a switching of the data from the modem to the encryption/decryption module or to the modulation/demodulation circuit, where the switching unit from the radiocommunication module is of the type controlled by software and placed between the said first software switching resource and the modem interface.

21. A telephone communication system according to claim 18, characterised in that the encryption/decryption module is inserted in a unit cover linked to the terminal module by a contactor.

22. A telephone communication system according to claim 18, characterised in that the encryption/decryption module includes a data media reader for the exchange only of the user's encryption session keys.

23. A telephone communication system according to claim 18, characterised in that the radiocommunication module includes a serial connection to an external modem.

24. A telephone communication system according to claim 23, characterised in that the serial connection is of the RS232 wire type.

25. A telephone communication system according to claim 23, characterised in that the serial connection is not of the wire type.

26. A telephone communication system according to claim 25, characterised in that the serial connection, not of the wire type, is infrared.

27. A telephone communication system according to claim 25, characterised in that the serial connection, not of the wire type, is 802.11 radio (WIFI).

28. A telephone communication system according to claim 25, characterised in that the serial connection, not of the wire type, is bluetooth.

29. A telephone communication system according to claim 18, characterised in that the conversation mode selected by the menu is a telephone call in plain language through the cellular radiotelephone network, directly connecting a DSP on send or receive with a radio modulation/demodulation circuit of the radiocommunication module.

30. A telephone communication system according to claim 18, characterised in that the conversation mode selected by the menu is an encrypted telephone call through the cellular radiotelephone network, where this mode inserts the encryption/decryption module by switching the switching unit of the first software switching resource between a DSP and a radio modulation/demodulation circuit of the radiocommunication module.

31. A telephone communication system according to claim 18, characterised in that the conversation mode selected by the menu is an encrypted telephone call through the switched telephone network or a satellite via an external modem controlled by the radiocommunication module, where, by switching the switching unit of the first software switching resource, this mode inserts, between the DSP and the encryption/decryption module, a vocoder circuit that adapts the digital signals of the DSP to the transmission speed of a modem before sending them to the encryption/decryption circuit and diverting the signals coming from the external modem exiting from the encryption decryption circuit to a loudspeaker and those coming from a microphone and exiting from the encryption/decryption circuit to the external modem.

32. A telephone communication system according to claim 18, characterised in that the mode of transmission of the data selected by the menu is a plain-language telephone transmission through the cellular radiotelephone network connecting the modem interface module with a radio modulation-demodulation circuit by switching the switching unit of the radiocommunication module.

33. A telephone communication system according to claim 18, characterised in that the mode of transmission of the data selected by the menu is an encrypted telephone transmission through the cellular radiotelephone network, inserting the encryption/decryption module between the modem interface module and the radio modulation-demodulation circuit, by switching the switching unit of the radiocommunication module.
